(19) United States
(12) Patent Application Publication
(10) Pub. No.: US 2026/0030018 A1
(43) Pub. Date: Jan. 29, 2026

(54) MACHINE LEARNING FOR PACKAGE VERSIONING AND USE

(71) Applicant: Capital One Services, LLC, McLean, VA (US)

(72) Inventors: Mohamed SECK, Aubrey, TX (US); Sesha Sowmya NADIMINTI, Glen Allen, VA (US)

(21) Appl. No.: 18/784,222

(22) Filed: Jul. 25, 2024

(51) Int. Cl. G06F 8/71; G06F 11/07; G06F 11/36

(52) U.S. Cl. CPC G06F 8/71; G06F 11/0784; G06F 11/3688

(57) ABSTRACT

In some implementations, a user device may transmit, to the package repository, a request for a code package. The user device may receive, from the package repository, an indication of a plurality of versions of the code package. The user device may receive, from the package repository, an indication of a suggested version from the plurality of versions. The suggested version is based on automatic testing of the code package by the package repository. The user device may transmit, to the package repository, a request for the suggested version. The user device may receive, from the package repository, at least one file included in the suggested version.

### BACKGROUND

Software code for an application may depend on code packages. For example, instructions in the software code may call functions in the code packages (whether in code form or in executable form, such as in libraries).

### SUMMARY

Some implementations described herein relate to a system for using a machine learning model on code packages. The system may include one or more memories and one or more processors communicatively coupled to the one or more memories. The one or more processors may be configured to receive a first version of a first code package. The one or more processors may be configured to compile, and perform a first set of tests on, the first version of the first code package. The one or more processors may be configured to provide a first set of results from the first set of tests to the machine learning model in order to generate a first score for the first version of the first code package. The one or more processors may be configured to receive a second version of the first code package. The one or more processors may be configured to compile, and perform the first set of tests on, the second version of the first code package. The one or more processors may be configured to provide a second set of results from the first set of tests to the machine learning model in order to generate a second score for the second version of the first code package, wherein the second score is worse than the first score. The one or more processors may be configured to receive, from a first user device, a request for the first code package. The one or more processors may be configured to transmit, to the first user device and in response to the request for the first code package, an indication to use the first version of the first code package based on the second score being worse than the first score. The one or more processors may be configured to receive a first version of a second code package. The one or more processors may be configured to compile, and perform a second set of tests on, the first version of the second code package in order to determine that the first version of the second code package is defective. The one or more processors may be configured to transmit, to a second user device, a message indicating that the first version of the second code package is defective.

Some implementations described herein relate to a method of selecting versions from a package repository. The method may include transmitting, to the package repository and from a user device, a request for a code package. The method may include receiving, from the package repository and at the user device, an indication of a plurality of versions of the code package. The method may include receiving, from the package repository and at the user device, an indication of a suggested version from the plurality of versions, wherein the suggested version is based on automatic testing of the code package by the package repository. The method may include transmitting, to the package repository and from the user device, a request for the suggested version. The method may include receiving, from the package repository and at the user device, at least one file included in the suggested version.

Some implementations described herein relate to a non-transitory computer-readable medium that stores a set of instructions for submitting to a package repository. The set of instructions, when executed by one or more processors of a device, may cause the device to transmit, to the package repository, a request to store a first version of a code package. The set of instructions, when executed by one or more processors of the device, may cause the device to receive, from the package repository, a message indicating that the first version of the code package is defective based on first test results at the package repository. The set of instructions, when executed by one or more processors of the device, may cause the device to transmit, to the package repository, a request to re-assess a second version of the code package. The set of instructions, when executed by one or more processors of the device, may cause the device to receive, from the package repository, a message indicating that the second version of the code package is accepted based on second test results at the package repository.

### BRIEF DESCRIPTION OF THE DRAWINGS

FIGS. 1A-1E are diagrams of an example implementation relating to machine learning for package versioning, in accordance with some embodiments of the present disclosure.

FIGS. 2A-2B are diagrams of an example implementation relating to machine learning for package use, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to machine learning for package versioning and use, in accordance with some embodiments of the present disclosure.

FIG. 6 is a flowchart of an example process relating to package use, in accordance with some embodiments of the present disclosure.

FIG. 7 is a flowchart of an example process relating to package versioning, in accordance with some embodiments of the present disclosure.

### DETAILED DESCRIPTION

The following detailed description of example implementations refers to the accompanying drawings. The same reference numbers in different drawings may identify the same or similar elements.

Software code for an application may depend on code packages. For example, a code package may include a set of files with software code (e.g., to be compiled), a set of files with bytecode (e.g., executable by an interpreter), or a library including executable functions (e.g., callable by a compiled software program). In order to provide more code packages to developers, a package repository may store and index code packages that can be downloaded by the developers. As more code packages are added to the package repository, memory overhead is increased.

Some developers may upload untested code packages to the package repository. As a result, developers may introduce bugs, security vulnerabilities, and/or other problems to software code by using an untested code package. Some developers may also upload multiple versions of a code package to the package repository. However, developers may default to a latest version of the code package even if a previous version of the code package is more reliable and/or safer. As a result, developers may introduce latency, increased memory overhead, and/or other issues to software code by using a subpar version of the code package.

Some implementations described herein enable a package repository to automatically test code packages. Therefore, the package repository may reject code packages that fail testing. As a result, the package repository prevents bugs, security vulnerabilities, and/or other problems that would have been caused by code packages that failed testing. Additionally, some implementations described herein enable the package repository to automatically test different versions of a code package. Therefore, the package repository may recommend a version of the code package based on test results (e.g., by using a machine learning model). As a result, the package repository prevents latency, increased memory overhead, and/or other issues that would have been caused by using a subpar version of the code package.

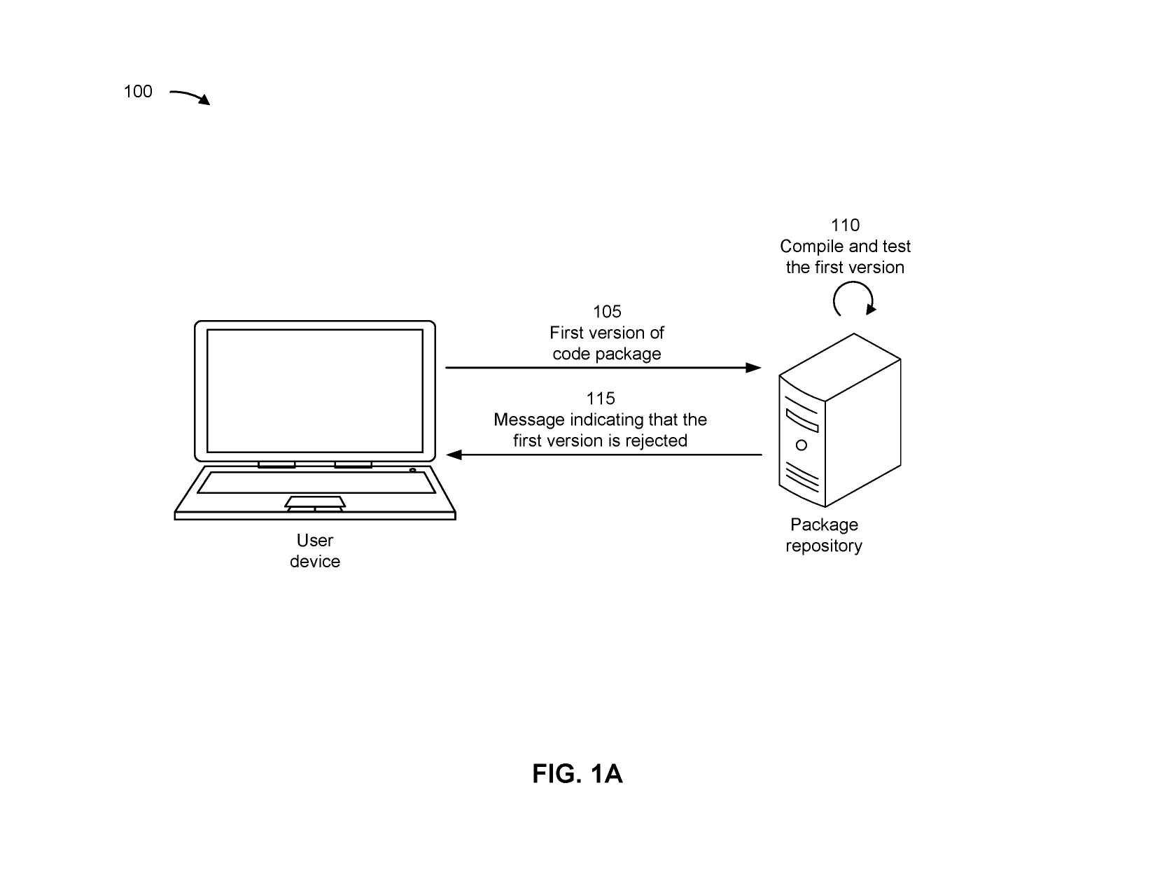

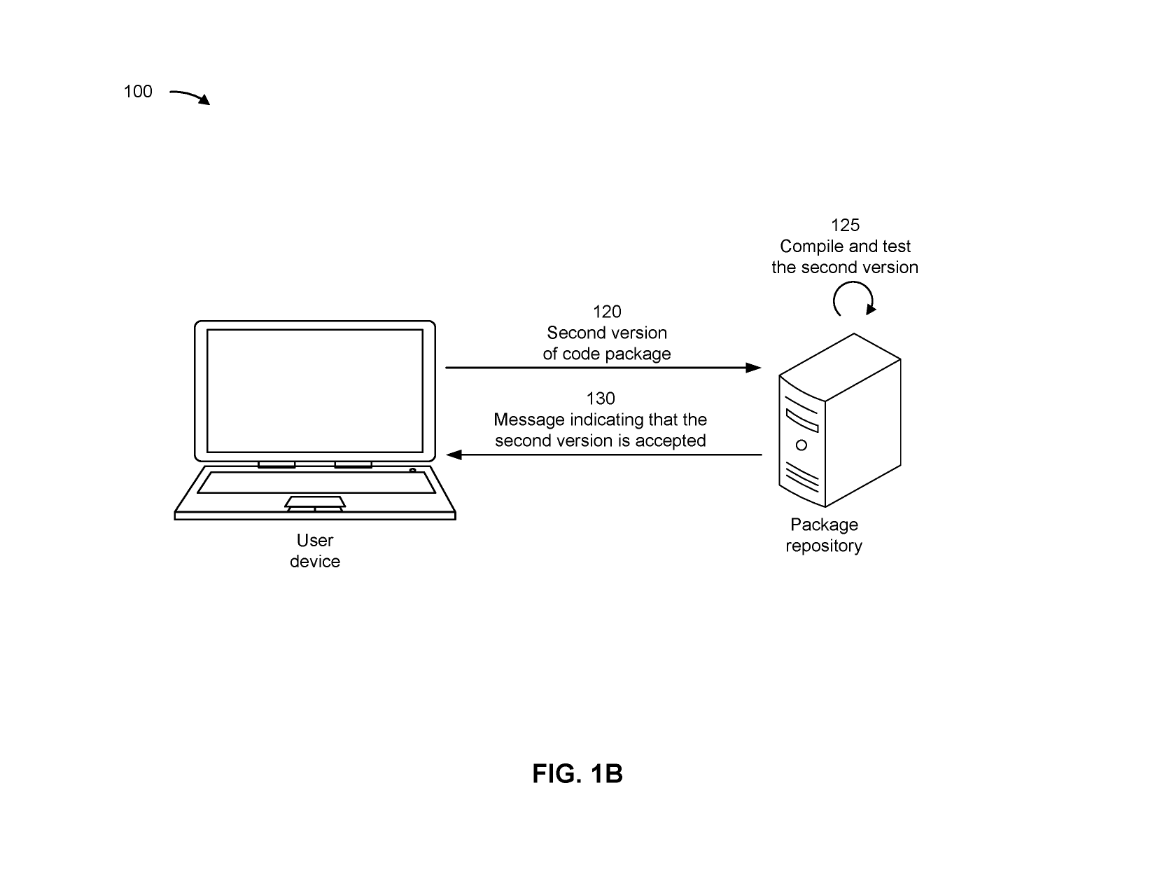

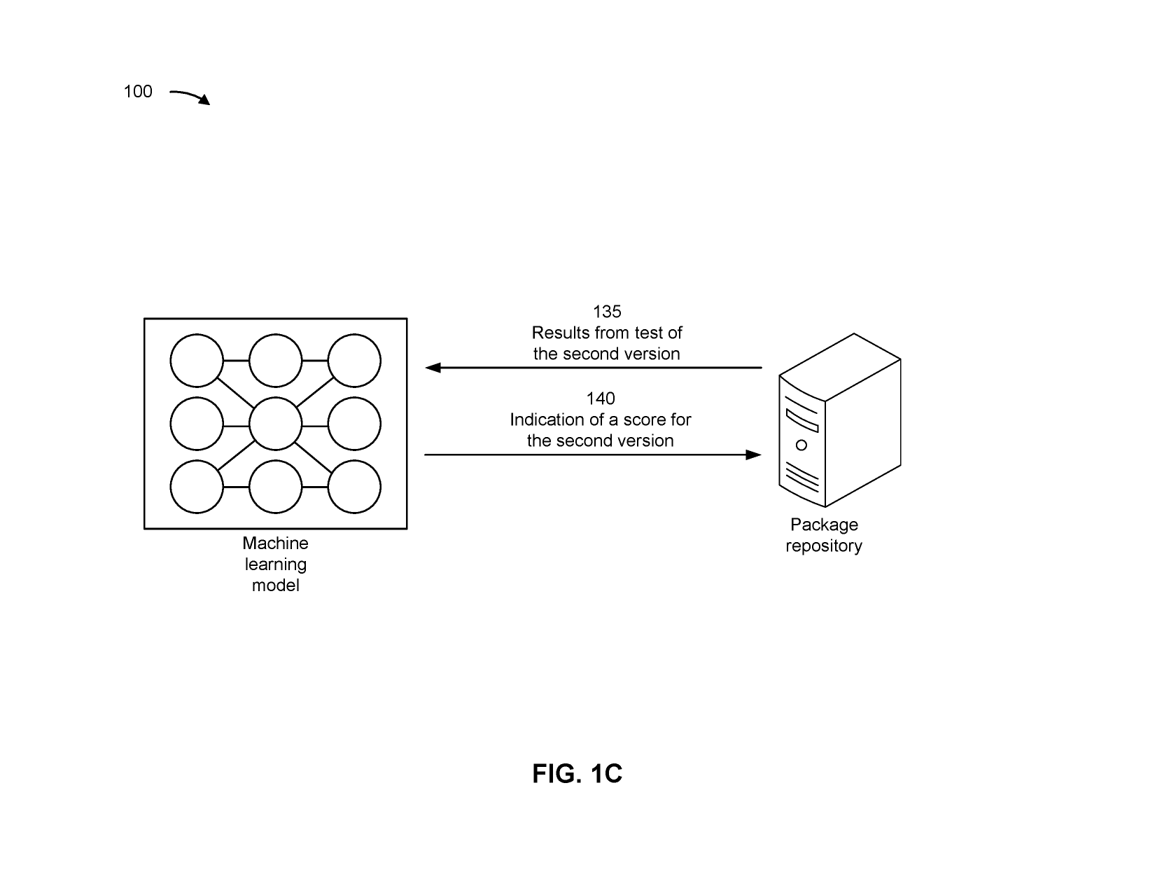

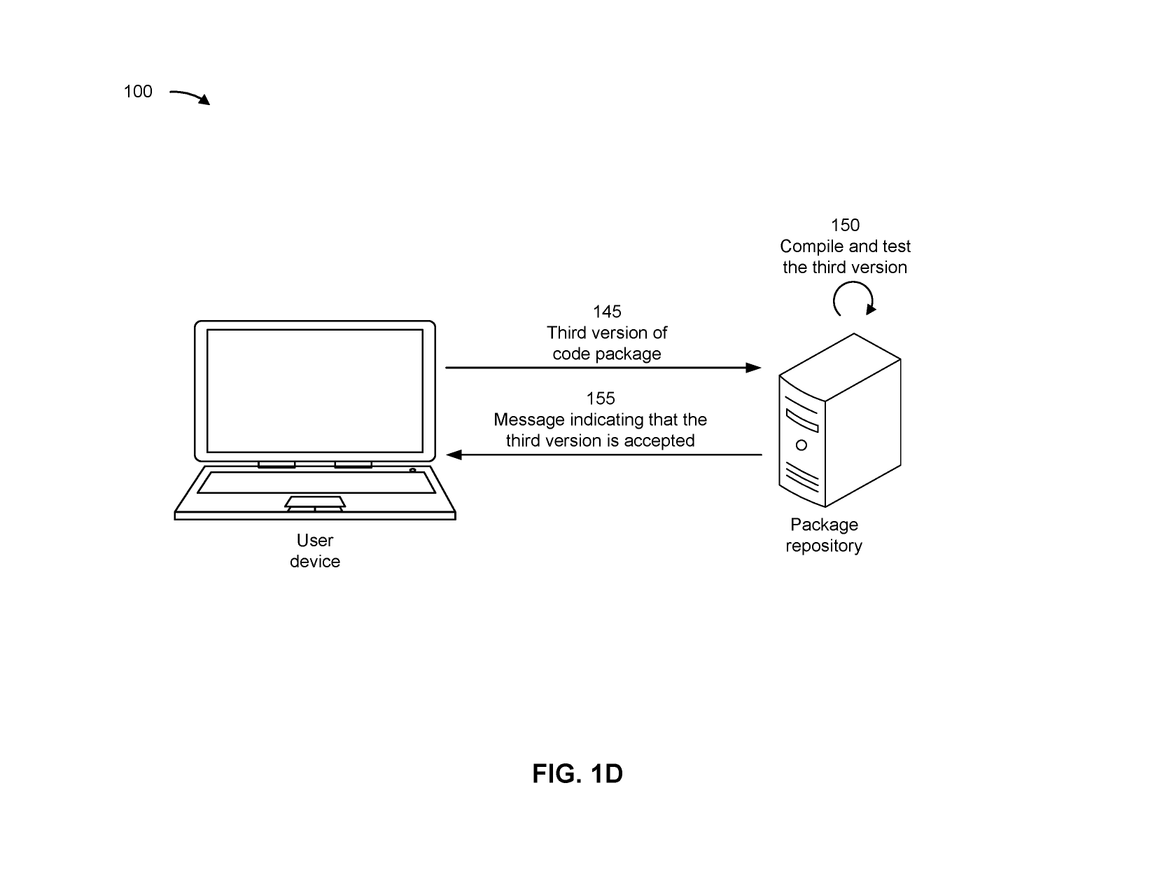

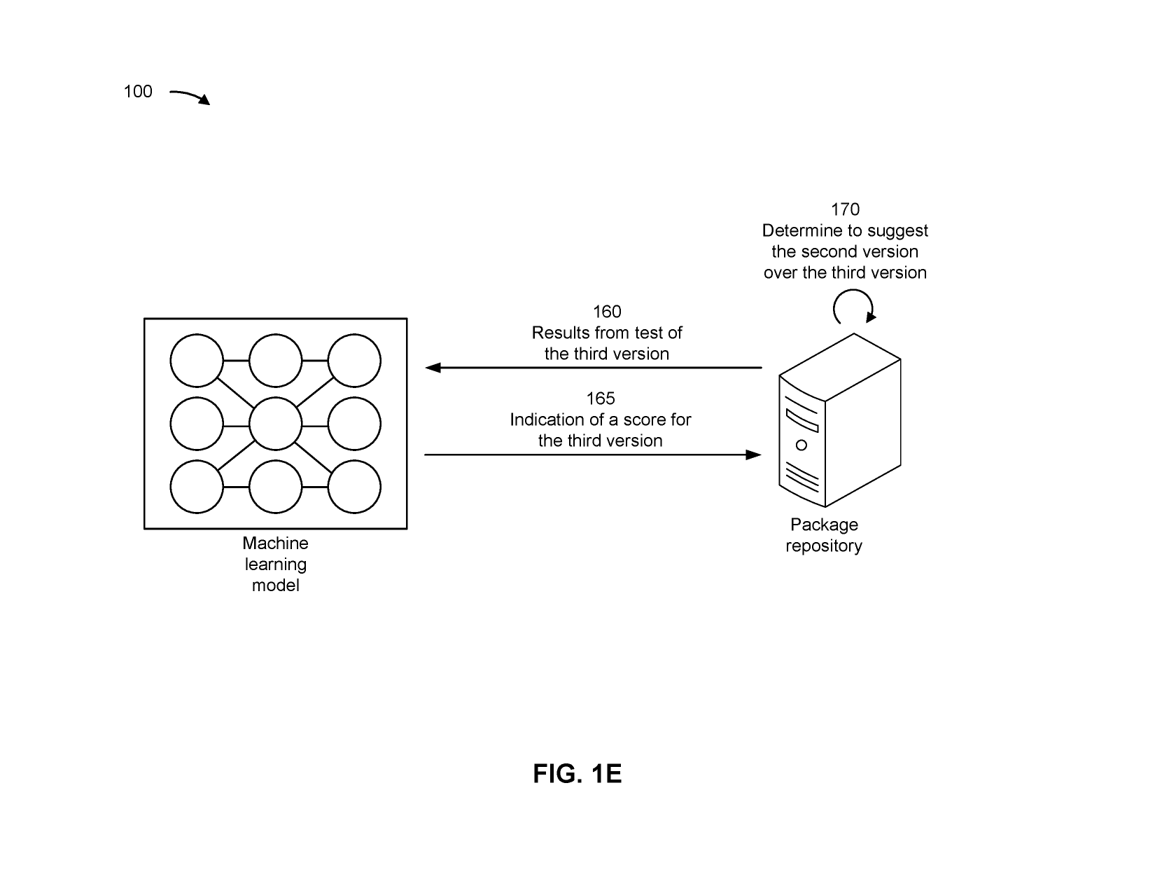

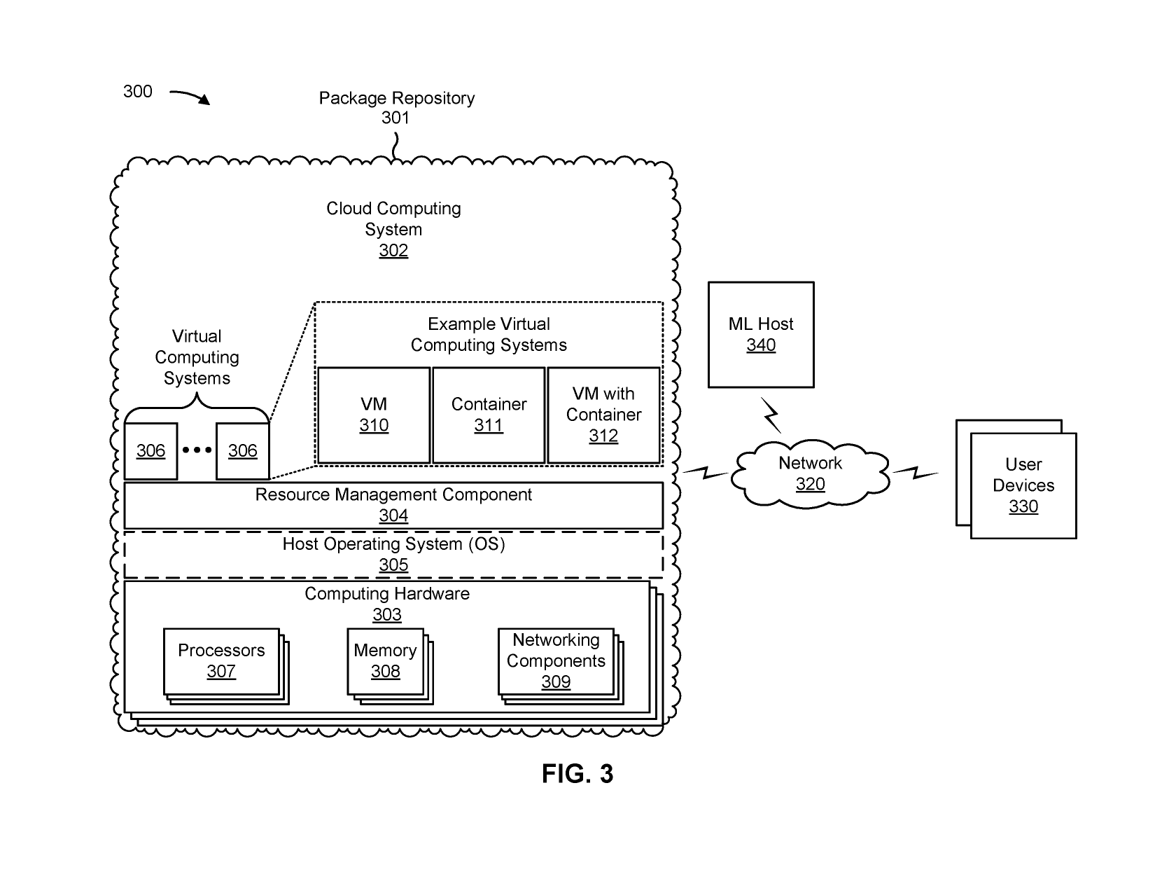

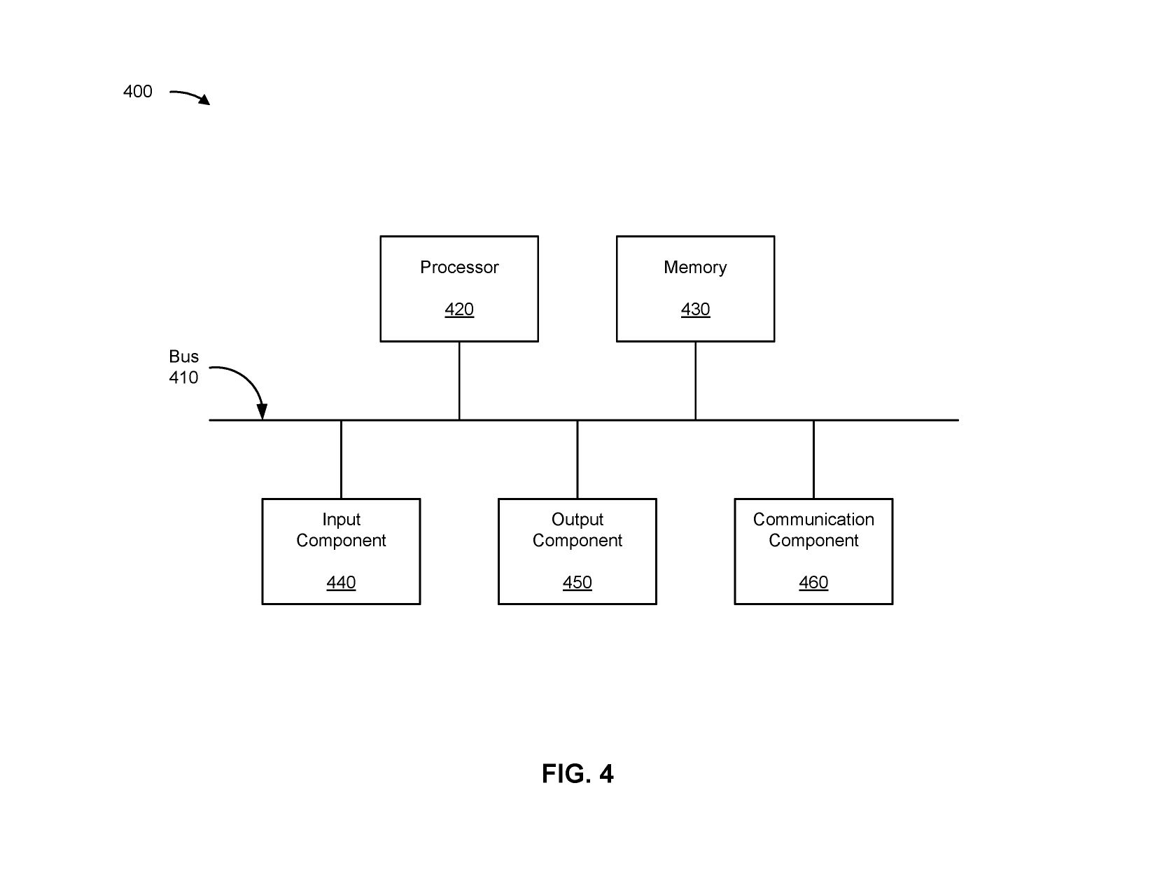

FIGS. 1A-1E are diagrams of an example 100 associated with machine learning for package versioning. As shown in FIGS. 1A-1E, example 100 includes a user device, a package repository, and a machine learning (ML) model (e.g., provided by an ML host). These devices are described in more detail in connection with FIGS. 3 and 4.

As shown in FIG. 1A and by reference number 105, the user device may transmit, and the package repository may receive, a first version of a code package. For example, the user device may transmit, and the package repository may receive, a request to store the first version of the code package. The request may include a hypertext transfer protocol (HTTP) request, a file transfer protocol (FTP) request, and/or an application programming interface (API) call. In some implementations, the user device may transmit, and the package repository may receive, a first set of files including computer code for the first version of the code package. The first set of files may be included in the request. Alternatively, the first set of files may be in a separate message. For example, the package repository may transmit (and the user device may receive) a prompt in response to the request, and the user device may transmit (and the package repository may receive) the first set of files in response to the prompt.

A user of the user device may trigger the user device to transmit the first version of the code package. For example, the user may provide input (e.g., using an input component of the user device) that triggers the user device to transmit the first version of the code package. In some implementations, the user device may output (e.g., using an output component of the user device) a user interface (UI), and the user may interact with the UI to provide the input. In one example, the user device may transmit (e.g., to a web host) a request for a webpage hosted by (or at least associated with) the package repository and may receive the webpage (e.g., from the web host) in response to the request for the webpage. Accordingly, the user device may output the webpage, and the user may interact with the webpage to provide the input. In another example, an application (also referred to as an “app” or “mobile app”) executed by the user device may generate the UI, and the user may interact with the UI of the application to provide the input.

In some implementations, the user device may transmit, and the package repository may receive, a set of credentials. The set of credentials may include a username and password, a secret answer, a certificate, a private key, a signature, and/or biometric information, among other examples. The package repository may accept the first version of the code package based on validating the set of credentials. For example, after validating the set of credentials, the package repository may transmit (and the user device may receive) a prompt, and the user device may transmit (and the package repository may receive) the first version of the code package in response to the prompt.

As shown by reference number 110, the package repository may compile, and perform a set of tests on, the first version of the code package. For example, the first version of the code package may include lower- or higher-level code that is compilable into machine-level instructions. Accordingly, the package repository may try to compile the first version of the code package and may determine that the first version of the code package is defective in response to any failure in compiling. The set of tests may further include a debugging test (e.g., at least one debugging test) or a security test (e.g., at least one security test). For example, the package repository may execute the first version of the code package (as compiled) in a debugging environment and may determine that the first version of the code package is defective in response to any runtime error detected in the debugging environment. Additionally, or alternatively, the package repository may simulate input to, and assess output from, the first version of the code package (as compiled) and may determine that the first version of the code package is defective in response to any error caused by the input and/or detected in the output.

Therefore, the package repository may refrain from storing (and indexing) the first version of the code package based on the first version of the code package being defective. As a result, the package repository reduces memory overhead. Additionally, the package repository prevents bugs, security vulnerabilities, and/or other problems that would have been caused by the first version of the code package.

Additionally, as shown by reference number 115, the package repository may transmit, and the user device may receive, a message indicating that the first version of the code package is rejected. For example, the message may indicate that the first version of the code package is defective based on test results at the package repository (e.g., from the set of tests, as described above). The message may include an email message or a push notification, among other examples. In some implementations, the package repository may transmit, and the user device may receive, the message in response to the request to store the first version of the code package (e.g., as described above).

Based on rejection of the first version of the code package, the user of the user device may develop a second version of the code package. For example, the user may adjust the computer code of the code package in order to generate the second version of the code package. As shown in FIG. 1B and by reference number 120, the user device may transmit, and the package repository may receive, the second version of the code package. For example, the user device may transmit, and the package repository may receive, a request to re-assess the second version of the code package. The request may include an HTTP request, an FTP request, and/or an API call. In some implementations, the user device may transmit, and the package repository may receive, a second set of files including computer code for the second version of the code package. The second set of files may be included in the request. Alternatively, the second set of files may be in a separate message. For example, the package repository may transmit (and the user device may receive) a prompt in response to the request, and the user device may transmit (and the package repository may receive) the second set of files in response to the prompt.

The user of the user device may trigger the user device to transmit the second version of the code package. For example, the user may provide input (e.g., using an input component of the user device) that triggers the user device to transmit the second version of the code package.

In some implementations, the user device may transmit, and the package repository may receive, the set of credentials. The package repository may accept the second version of the code package based on validating the set of credentials. Alternatively, the package repository may accept the second version of the code package based on previously validating the set of credentials (e.g., before accepting the first version of the code package).

As shown by reference number 125, the package repository may compile, and perform the set of tests on, the second version of the code package. For example, the package repository may try to compile the second version of the code package and may determine that the second version of the code package is valid in response to successfully compiling the second version of the code package. Additionally, or alternatively, the package repository may execute the second version of the code package (as compiled) in a debugging environment and may determine that the second version of the code package is valid in response to a lack of runtime errors detected in the debugging environment. Additionally, or alternatively, the package repository may simulate input to, and assess output from, the second version of the code package (as compiled) and may determine that the second version of the code package is valid in response to a lack of errors caused by the input and/or detected in the output.

Therefore, the package repository may store (and index) the second version of the code package based on the second version of the code package being valid. Additionally, as shown by reference number 130, the package repository may transmit, and the user device may receive, a message indicating that the second version of the code package is accepted. For example, the message may indicate that the second version of the code package is valid based on test results at the package repository (e.g., from the set of tests, as described above). The message may include an email message or a push notification, among other examples. In some implementations, the package repository may transmit, and the user device may receive, the message in response to the request to re-assess the second version of the code package (e.g., as described above).

Although the example 100 is described using two versions of the code package, other examples may include a single version or additional versions. For example, the package repository may accept the first version of the code package based on determining that the first version of the code package is valid. In another example, the package repository may reject the second version of the code package (e.g., based on determining that the second version of the code package is defective) and may accept a third version of the code package (e.g., based on determining that the third version of the code package is valid). Accordingly, operations described in connection with FIGS. 1A-1B may be performed iteratively.

The package repository may also assess quality of the second version of the code package based on the test results (e.g., from the set of tests, as described above). For example, as shown in FIG. 1C, the package repository may apply the ML model to score the second version of the code package. As shown by reference number 135, the package repository may provide, to the ML model, a set of results from the set of tests (performed on the second version of the code package). For example, the package repository may provide execution times, instruction sequence measurements, memory flow measurements, input latencies, output latencies, sample input data packets, and/or sample output data packets, among other examples, to the ML model. In some implementations, the package repository may transmit, and the ML host associated with the ML model may receive, a request including the set of results. The ML model may be trained (e.g., by the ML host and/or a device at least partially separate from the ML host) to score versions of code packages. The ML model may be trained using code packages that are labeled by administrators or other types of users (e.g., for supervised learning). Additionally, or alternatively, the ML model may be trained using code packages that are unlabeled (e.g., for deep learning).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

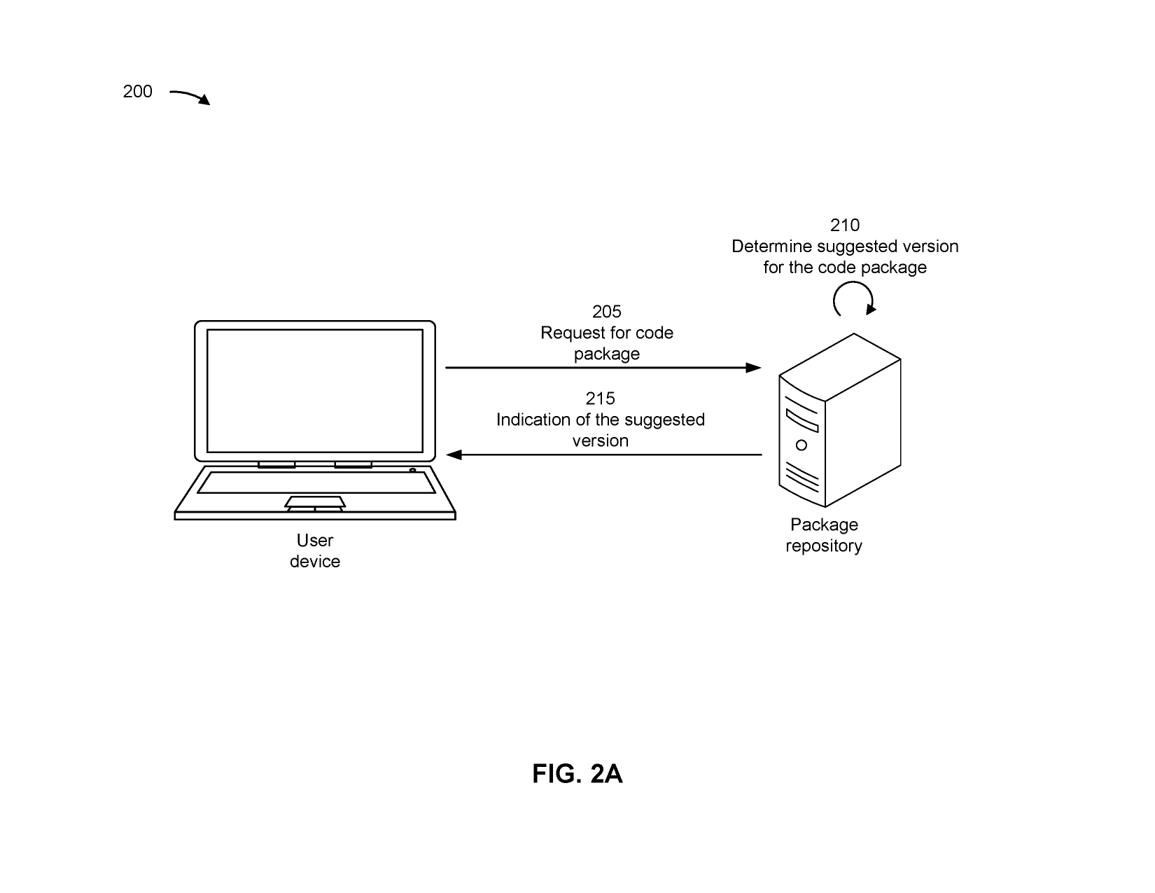

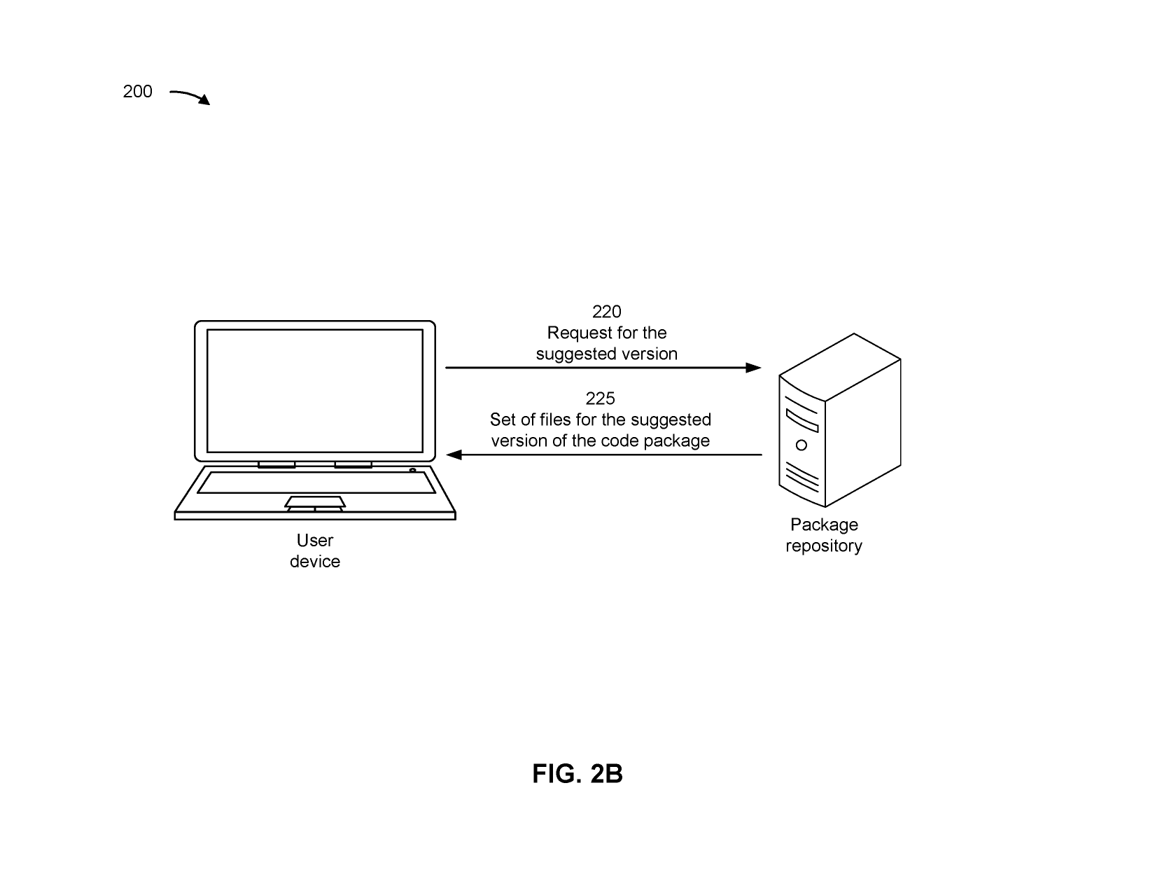

As shown by reference number 140, the ML model may output a score for the second version of the code package. For example, the package repository may receive the score from the ML model (e.g., from the ML host). The score may be encoded as an integer, a decimal, or another type of data structure. Therefore, the package repository may make the second version of the code package available to a set of developers (e.g., as described in connection with FIGS. 2A-2B) along with the score.

The user of the user device may develop a third version of the code package. For example, the user may add to, or otherwise attempt to improve, the computer code of the code package in order to generate the third version of the code package. As shown in FIG. 1D and by reference number 145, the user device may transmit, and the package repository may receive, the third version of the code package. For example, the user device may transmit, and the package repository may receive, a request to store the third version of the code package. The request may include an HTTP request, an FTP request, and/or an API call. In some implementations, the user device may transmit, and the package repository may receive, a third set of files including computer code for the third version of the code package. The third set of files may be included in the request. Alternatively, the third set of files may be in a separate message. For example, the package repository may transmit (and the user device may receive) a prompt in response to the request, and the user device may transmit (and the package repository may receive) the third set of files in response to the prompt.

The user of the user device may trigger the user device to transmit the third version of the code package. For example, the user may provide input (e.g., using an input component of the user device) that triggers the user device to transmit the third version of the code package.

In some implementations, the user device may transmit, and the package repository may receive, the set of credentials. The package repository may accept the third version of the code package based on validating the set of credentials. Alternatively, the package repository may accept the third version of the code package based on previously validating the set of credentials (e.g., before accepting the first version and/or the second version of the code package).

As shown by reference number 150, the package repository may compile, and perform the set of tests on, the third version of the code package. For example, the package repository may try to compile the third version of the code package and may determine that the third version of the code package is valid in response to successfully compiling the third version of the code package. Additionally, or alternatively, the package repository may execute the third version of the code package (as compiled) in a debugging environment and may determine that the third version of the code package is valid in response to a lack of runtime errors detected in the debugging environment. Additionally, or alternatively, the package repository may simulate input to, and assess output from, the third version of the code package (as compiled) and may determine that the third version of the code package is valid in response to a lack of errors caused by the input and/or detected in the output.

Therefore, the package repository may store (and index) the third version of the code package based on the third version of the code package being valid. Additionally, as shown by reference number 155, the package repository may transmit, and the user device may receive, a message indicating that the third version of the code package is accepted. For example, the message may indicate that the third version of the code package is valid based on test results at the package repository (e.g., from the set of tests, as described above). The message may include an email message or a push notification, among other examples. In some implementations, the package repository may transmit, and the user device may receive, the message in response to the request to store the third version of the code package (e.g., as described above).

The package repository may also assess quality of the third version of the code package based on the test results (e.g., from the set of tests, as described above). For example, as shown in FIG. 1E, the package repository may apply the ML model to score the third version of the code package. As shown by reference number 160, the package repository may provide, to the ML model, an additional set of results from the set of tests (performed on the third version of the code package). In some implementations, the package repository may transmit, and the ML host associated with the ML model may receive, a request including the additional set of results. As described above, the ML model may be trained (e.g., by the ML host and/or a device at least partially separate from the ML host) to score versions of code packages.

As shown by reference number 165, the ML model may output a score for the third version of the code package. For example, the package repository may receive the score from the ML model (e.g., from the ML host). Therefore, the package repository may make the third version of the code package available to a set of developers (e.g., as described in connection with FIGS. 2A-2B) along with the score.

Even though the third version is newer than the second version, the score for the third version may be worse than the score for the second version. For example, if the ML model generates higher scores to represent better quality, the third version may be associated with a lower score than the second version. In another example, if the ML model generates lower scores to represent better quality, the third version may be associated with a higher score than the second version.

As shown by reference number 170, the package repository may determine to suggest the second version over the third version. For example, the package repository may determine that the score for the second version is better than the score for the third version. Accordingly, the package repository may output an indication of the second version being a suggested version (e.g., as described in connection with FIG. 2A). As a result, the package repository prevents latency, increased memory overhead, and/or other issues that would have been caused by the third version of the code package.

As indicated above, FIGS. 1A-1E are provided as an example. Other examples may differ from what is described with regard to FIGS. 1A-1E.

FIGS. 2A-2B are diagrams of an example 200 associated with machine learning for package use. As shown in FIGS. 2A-2B, example 200 includes a user device and a package repository. These devices are described in more detail in connection with FIGS. 3 and 4.

As shown in FIG. 2A and by reference number 205, the user device may transmit, and the package repository may receive, a request for a code package. The request may include an HTTP request, an FTP request, and/or an API call. The request may include (e.g., in a header and/or as an argument) an identifier associated with the code package. The identifier may include a name and/or another type of alphanumeric identifier. In some implementations, the code package may include a set of files including computer code, a set of bytecode, and/or a library (e.g., at least one library) including executable functions.

A user of the user device may trigger the user device to transmit the request for the code package. For example, the user may provide input (e.g., using an input component of the user device) that triggers the user device to transmit the request. The input may include the identifier associated with the code package. In some implementations, the user device may output (e.g., using an output component of the user device) a UI, and the user may interact with the UI to provide the input. In one example, the user device may transmit (e.g., to a web host) a request for a webpage hosted by (or at least associated with) the package repository and may receive the webpage (e.g., from the web host) in response to the request for the webpage. Accordingly, the user device may output the webpage, and the user may interact with the webpage to provide the input. In another example, an application (also referred to as an “app” or “mobile app”) executed by the user device may generate the UI, and the user may interact with the UI of the application to provide the input.

In some implementations, the user device may transmit, and the package repository may receive, a set of credentials. The set of credentials may include a username and password, a secret answer, a certificate, a private key, a signature, and/or biometric information, among other examples. The package repository may accept the request for the code package based on validating the set of credentials. For example, after validating the set of credentials, the package repository may transmit (and the user device may receive) a prompt, and the user device may transmit (and the package repository may receive) the request in response to the prompt.

In some implementations, the package repository may transmit, and the user device may receive, an indication of a plurality of versions of the code package. In some implementations, the indication of the plurality of versions may be represented in a UI. For example, the UI may include a list of versions (e.g., in text, in a drop-down menu, and/or in a set of radio buttons, among other examples). The package repository may transmit, and the user device may receive, instructions for the UI. Accordingly, the user device may output (e.g., via an output component of the user device) the UI to the user.

As shown by reference number 210, the package repository may determine a suggested version, for the code package, from the plurality of versions. The suggested version may be based on automatic testing of the code package (e.g., as described in connection with FIGS. 1A, 1B, and 1D). Therefore, the suggested version may be based on a score for the suggested version (e.g., as described in connection with FIGS. 1C and 1E). For example, the suggested version may be associated with a score that is better than other scores associated with remaining versions in the plurality of versions. In other words, the scores associated with the remaining versions, in the plurality of versions, may be worse than the score associated with the suggested version. Therefore, the package repository may determine the suggested version based on the suggested version being associated with a highest score in a respective plurality of scores associated with the plurality of versions.

As shown by reference number 215, the package repository may transmit, and the user device may receive, an indication of the suggested version. In some implementations, the indication of the suggested version may be included in the UI (representing the plurality of versions, as described above). For example, the indication of the suggested version may be a visual indicator (e.g., text, a color, and/or an icon, among other examples) included in the UI. The package repository may transmit, and the user device may receive, instructions for the visual indicator. Accordingly, the user device may output (e.g., via an output component of the user device) the visual indicator (as part of the UI) to the user. In some implementations, the plurality of versions may be associated with a respective plurality of scores, as described above, and the indication of the suggested version may indicate that the suggested version is associated with a highest score in the respective plurality of scores.

As shown in FIG. 2B and by reference number 220, the user device may transmit, and the package repository may receive, a request for the suggested version (of the code package). The request may include an HTTP request, an FTP request, and/or an API call. The user of the user device may trigger the user device to transmit the request. For example, the user may provide input (e.g., using an input component of the user device) that triggers the user device to transmit the request.

In some implementations, the user device may transmit, and the package repository may receive, the set of credentials. The package repository may accept the request for the suggested version based on validating the set of credentials. Alternatively, the package repository may accept the request for the suggested version based on previously validating the set of credentials (e.g., before accepting the request for the code package).

As shown by reference number 225, the package repository may transmit, and the user device may receive, a set of files (e.g., at least one file) included in the suggested version (of the code package). The package repository may transmit, and the user device may receive, the set of files in response to the request for the suggested version.

By using techniques as described in connection with FIGS. 2A-2B, the package repository may indicate the suggested version of the code package based on test results associated with the code package (e.g., by using an ML model, as described in connection with FIGS. 1C and 1E). As a result, the package repository prevents latency, increased memory overhead, and/or other issues that would have been caused by using a subpar version of the code package.

As indicated above, FIGS. 2A-2B are provided as an example. Other examples may differ from what is described with regard to FIGS. 2A-2B.

FIG. 3 is a diagram of an example environment 300 in which systems and/or methods described herein may be implemented. As shown in FIG. 3, environment 300 may include a package repository 301, which may include one or more elements of and/or may execute within a cloud computing system 302. The cloud computing system 302 may include one or more elements 303-312, as described in more detail below. As further shown in FIG. 3, environment 300 may include a network 320, a set of user devices 330 and/or an ML host 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the package repository 301 may include one or more elements 303-312 of the cloud computing system 302, may execute within the cloud computing system 302, and/or may be hosted within the cloud computing system 302, in some implementations, the package repository 301 may not be cloud-based (e.g., may be implemented outside of a cloud computing system) or may be partially cloud-based. For example, the package repository 301 may include one or more devices that are not part of the cloud computing system 302, such as device 400 of FIG. 4, which may include a standalone server or another type of computing device. The package repository 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The set of user devices 330 may include one or more devices capable of receiving, generating, storing, processing, and/or providing information associated with code packages, as described elsewhere herein. The set of user devices 330 may include a communication device and/or a computing device. For example, the set of user devices 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The set of user devices 330 may communicate with one or more other devices of environment 300, as described elsewhere herein.

The ML host 340 may include one or more devices capable of receiving, generating, storing, processing, and/or providing information associated with machine learning models, as described elsewhere herein. The ML host 340 may include a communication device and/or a computing device. For example, the ML host 340 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 340 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with machine learning for package versioning and use. The device 400 may correspond to a user device 330 and/or an ML host 340. In some implementations, a user device 330 and/or an ML host 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

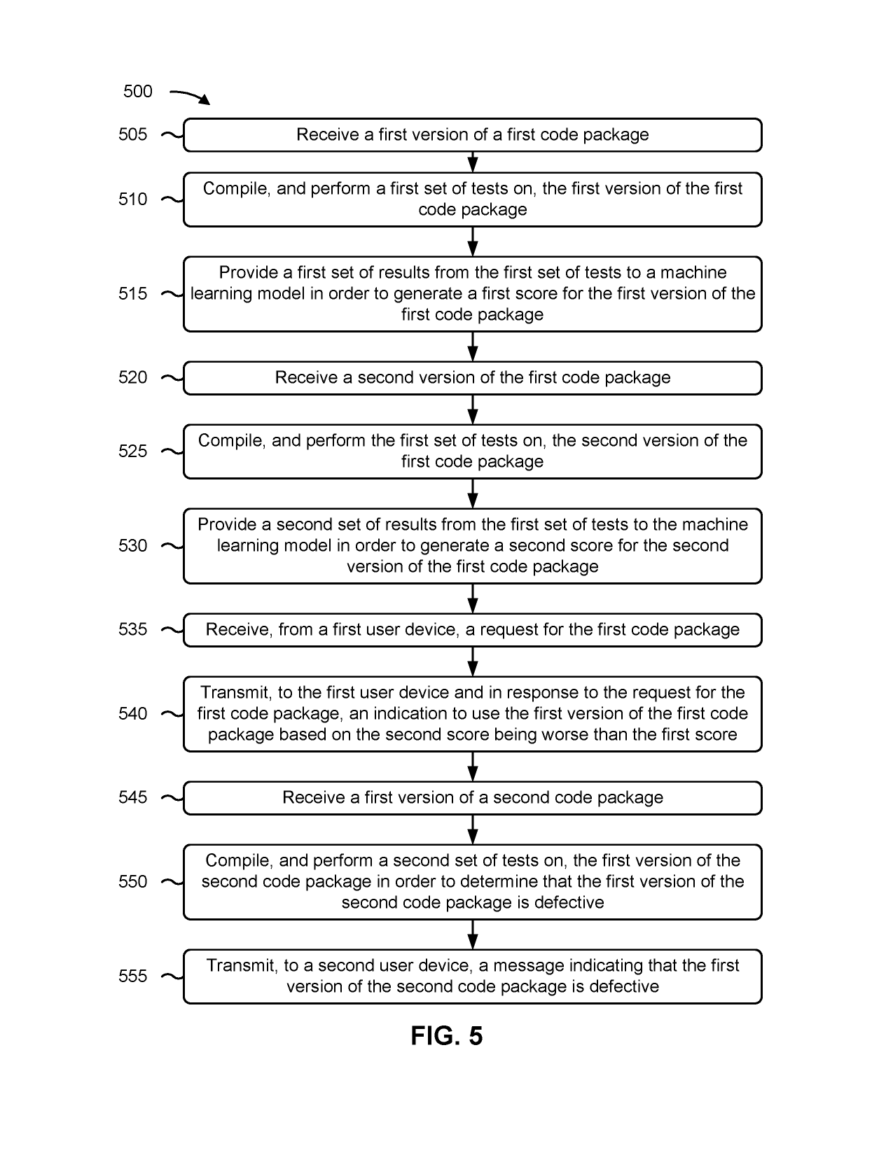

FIG. 5 is a flowchart of an example process 500 associated with machine learning for package versioning and use. In some implementations, one or more process blocks of FIG. 5 may be performed by a package repository 301. In some implementations, one or more process blocks of FIG. 5 may be performed by another device or a group of devices separate from or including the package repository 301, such as a user device 330 and/or an ML host 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a first version of a first code package (block 505). For example, the package repository 301 (e.g., using processor 420, memory 430, and/or communication component 460) may receive a first version of a first code package, as described above in connection with reference number 105 of FIG. 1A. As an example, the package repository 301 may receive (e.g., from a user device) a first set of files including computer code for the first version of the first code package.

As further shown in FIG. 5, process 500 may include compiling, and performing a first set of tests on, the first version of the first code package (block 510). For example, the package repository 301 (e.g., using processor 420 and/or memory 430) may compile, and perform a first set of tests on, the first version of the first code package, as described above in connection with reference number 110 of FIG. 1A. As an example, the package repository 301 may try to compile the first version of the first code package. The first set of tests may further include at least one debugging test and/or at least one security test. For example, the package repository 301 may execute the first version of the first code package (as compiled) in a debugging environment and may determine if any runtime errors were detected in the debugging environment. Additionally, or alternatively, the package repository 301 may simulate input to, and assess output from, the first version of the first code package (as compiled) and may determine if any errors were caused by the input and/or were detected in the output.

As further shown in FIG. 5, process 500 may include providing a first set of results from the first set of tests to a machine learning model in order to generate a first score for the first version of the first code package (block 515). For example, the package repository 301 (e.g., using processor 420, memory 430, and/or communication component 460) may provide a first set of results from the first set of tests to a machine learning model in order to generate a first score for the first version of the first code package, as described above in connection with FIG. 1C. As an example, the machine learning model may be trained (e.g., by an ML host and/or a device at least partially separate from the ML host) to score versions of code packages. The first score may be encoded as an integer, a decimal, or another type of data structure.

As further shown in FIG. 5, process 500 may include receiving a second version of the first code package (block 520). For example, the package repository 301 (e.g., using processor 420, memory 430, and/or communication component 460) may receive a second version of the first code package, as described above in connection with reference number 120 of FIG. 1B. As an example, the package repository 301 may receive (e.g., from the user device) a second set of files including computer code for the second version of the first code package.

As further shown in FIG. 5, process 500 may include compiling, and performing the first set of tests on, the second version of the first code package (block 525). For example, the package repository 301 (e.g., using processor 420 and/or memory 430) may compile, and perform the first set of tests on, the second version of the first code package, as described above in connection with reference number 125 of FIG. 1B. As an example, the package repository 301 may try to compile the second version of the first code package. Additionally, or alternatively, the package repository 301 may execute the second version of the first code package (as compiled) in a debugging environment and may determine if any runtime errors were detected in the debugging environment. Additionally, or alternatively, the package repository 301 may simulate input to, and assess output from, the second version of the first code package (as compiled) and may determine if any errors were caused by the input and/or were detected in the output.

As further shown in FIG. 5, process 500 may include providing a second set of results from the first set of tests to the machine learning model in order to generate a second score for the second version of the first code package (block 530). For example, the package repository 301 (e.g., using processor 420, memory 430, and/or communication component 460) may provide a second set of results from the first set of tests to the machine learning model in order to generate a second score for the second version of the first code package, as described above in connection with FIG. 1C. The second score may be encoded as an integer, a decimal, or another type of data structure. The second score may be worse than the first score.

As further shown in FIG. 5, process 500 may include receiving, from a first user device, a request for the first code package (block 535). For example, the package repository 301 (e.g., using processor 420, memory 430, and/or communication component 460) may receive, from a first user device, a request for the first code package, as described above in connection with reference number 205 of FIG. 2A. As an example, the request may include an HTTP request, an FTP request, and/or an API call, and the request may include (e.g., in a header and/or as an argument) an identifier associated with the code package (e.g., a name and/or another type of alphanumeric identifier).

As further shown in FIG. 5, process 500 may include transmitting, to the first user device and in response to the request for the first code package, an indication to use the first version of the first code package based on the second score being worse than the first score (block 540). For example, the package repository 301 (e.g., using processor 420, memory 430, and/or communication component 460) may transmit, to the first user device and in response to the request for the first code package, an indication to use the first version of the first code package based on the second score being worse than the first score, as described above in connection with reference number 215 of FIG. 2A. As an example, the package repository 301 may transmit, to the first user device, instructions for a visual indicator (e.g., in a UI) that the first version of the first code package is a suggested version of the first code package.

As further shown in FIG. 5, process 500 may include receiving a first version of a second code package (block 545). For example, the package repository 301 (e.g., using processor 420, memory 430, and/or communication component 460) may receive a first version of a second code package, as described above in connection with FIG. 1A. As an example, the package repository 301 may receive (e.g., from a user device) a third set of files including computer code for the first version of the second code package.

As further shown in FIG. 5, process 500 may include compiling, and performing a second set of tests on, the first version of the second code package in order to determine that the first version of the second code package is defective (block 550). For example, the package repository 301 (e.g., using processor 420 and/or memory 430) may compile, and perform a second set of tests on, the first version of the second code package in order to determine that the first version of the second code package is defective, as described above in connection with FIG. 1A. As an example, the package repository 301 may try to compile the first version of the second code package and may determine that the first version of the second code package is defective in response to any failure in compiling. The second set of tests may further include at least one debugging test and/or at least one security test. For example, the package repository 301 may execute the first version of the second code package (as compiled) in a debugging environment and may determine that the first version of the second code package is defective in response to any runtime error detected in the debugging environment. Additionally, or alternatively, the package repository 301 may simulate input to, and assess output from, the first version of the second code package (as compiled) and may determine that the first version of the second code package is defective in response to any error caused by the input and/or detected in the output.

As further shown in FIG. 5, process 500 may include transmitting, to a second user device, a message indicating that the first version of the second code package is defective (block 555). For example, the package repository 301 (e.g., using processor 420, memory 430, and/or communication component 460) may transmit, to a second user device, a message indicating that the first version of the second code package is defective, as described above in connection with FIG. 1A. As an example, the message may indicate that the first version of the code package is rejected based on test results at the package repository 301 (e.g., from the second set of tests, as described above). The message may include an email message or a push notification, among other examples.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

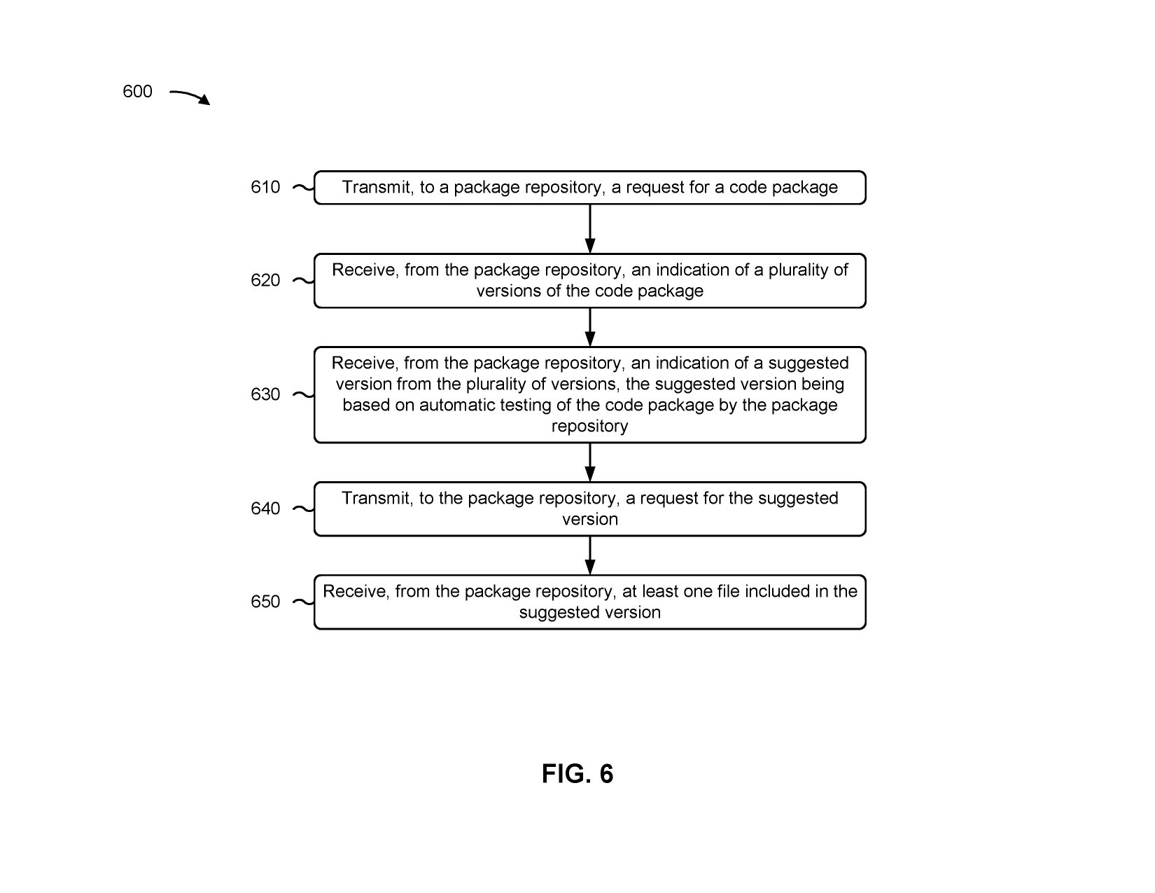

FIG. 6 is a flowchart of an example process 600 associated with package use. In some implementations, one or more process blocks of FIG. 6 may be performed by a user device 330. In some implementations, one or more process blocks of FIG. 6 may be performed by another device or a group of devices separate from or including the user device 330, such as a package repository 301 and/or an ML host 340. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a package repository, a request for a code package (block 610). For example, the user device 330 (e.g., using processor 420, memory 430, and/or communication component 460) may transmit, to a package repository, a request for a code package, as described above in connection with reference number 205 of FIG. 2A. As an example, a user of the user device 330 may trigger the user device 330 to transmit the request for the code package. For example, the user may provide input (e.g., using input component 440) that triggers the user device 330 to transmit the request.

As further shown in FIG. 6, process 600 may include receiving, from the package repository, an indication of a plurality of versions of the code package (block 620). For example, the user device 330 (e.g., using processor 420, memory 430, and/or communication component 460) may receive, from the package repository, an indication of a plurality of versions of the code package, as described above in connection with FIG. 2A. As an example, the indication of the plurality of versions may be represented in a UI. The user device 330 may receive (from the package repository) instructions for the UI, and the user device 330 may output (e.g., via output component 450) the UI to the user.

As further shown in FIG. 6, process 600 may include receiving, from the package repository, an indication of a suggested version from the plurality of versions, the suggested version being based on automatic testing of the code package by the package repository (block 630). For example, the user device 330 (e.g., using processor 420, memory 430, and/or communication component 460) may receive, from the package repository, an indication of a suggested version from the plurality of versions, the suggested version being based on automatic testing of the code package by the package repository, as described above in connection with reference number 215 of FIG. 2A. As an example, the indication of the suggested version may be a visual indicator (e.g., text, a color, and/or an icon, among other examples). The user device 330 may receive (from the package repository) instructions for the visual indicator, and the user device 330 may output (e.g., via output component 450) the visual indicator to the user.

As further shown in FIG. 6, process 600 may include transmitting, to the package repository, a request for the suggested version (block 640). For example, the user device 330 (e.g., using processor 420, memory 430, and/or communication component 460) may transmit, to the package repository, a request for the suggested version, as described above in connection with reference number 220 of FIG. 2B. As an example, the user of the user device 330 may trigger the user device 330 to transmit the request for the suggested version. For example, the user may provide input (e.g., using input component 440) that triggers the user device 330 to transmit the request.

As further shown in FIG. 6, process 600 may include receiving, from the package repository, at least one file included in the suggested version (block 650). For example, the user device 330 (e.g., using processor 420, memory 430, and/or communication component 460) may receive, from the package repository, at least one file included in the suggested version, as described above in connection with reference number 225 of FIG. 2B. As an example, the user device 330 may receive, from the package repository, the at least one file in response to the request for the suggested version.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 2A-2B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

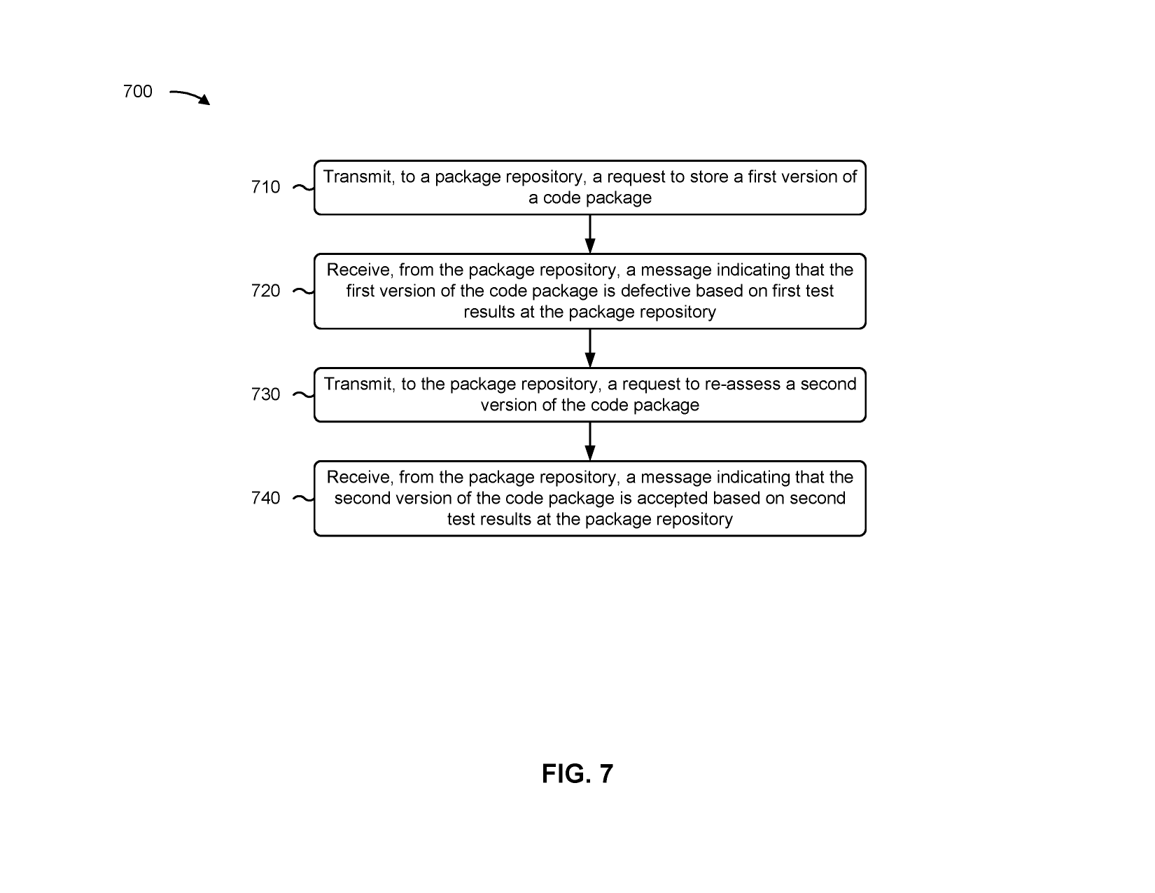

FIG. 7 is a flowchart of an example process 700 associated with package versioning. In some implementations, one or more process blocks of FIG. 7 may be performed by a user device 330. In some implementations, one or more process blocks of FIG. 7 may be performed by another device or a group of devices separate from or including the user device 330, such as a package repository 301 and/or an ML host 340. Additionally, or alternatively, one or more process blocks of FIG. 7 may be performed by one or more components of the device 400, such as processor 420, memory 430, input component 440, output component 450, and/or communication component 460.

As shown in FIG. 7, process 700 may include transmitting, to a package repository, a request to store a first version of a code package (block 710). For example, the user device 330 (e.g., using processor 420, memory 430, and/or communication component 460) may transmit, to a package repository, a request to store a first version of a code package, as described above in connection with FIG. 1A. As an example, a user of the user device 330 may trigger the user device 330 to transmit the request to store the first version of the code package. For example, the user may provide input (e.g., using input component 440) that triggers the user device 330 to transmit the request.

As further shown in FIG. 7, process 700 may include receiving, from the package repository, a message indicating that the first version of the code package is defective based on first test results at the package repository (block 720). For example, the user device 330 (e.g., using processor 420, memory 430, and/or communication component 460) may receive, from the package repository, a message indicating that the first version of the code package is defective based on first test results at the package repository, as described above in connection with reference number 115 of FIG. 1A. As an example, the message may indicate that the first version of the code package is rejected based on the first test results. The message may include an email message or a push notification, among other examples.

As further shown in FIG. 7, process 700 may include transmitting, to the package repository, a request to re-assess a second version of the code package (block 730). For example, the user device 330 (e.g., using processor 420, memory 430, and/or communication component 460) may transmit, to the package repository, a request to re-assess a second version of the code package, as described above in connection with reference number 120 of FIG. 1B. As an example, the user of the user device 330 may trigger the user device 330 to transmit the request to re-assess the second version of the code package. For example, the user may provide input (e.g., using input component 440) that triggers the user device 330 to transmit the request.

As further shown in FIG. 7, process 700 may include receiving, from the package repository, a message indicating that the second version of the code package is accepted based on second test results at the package repository (block 740). For example, the user device 330 (e.g., using processor 420, memory 430, and/or communication component 460) may receive, from the package repository, a message indicating that the second version of the code package is accepted based on second test results at the package repository, as described above in connection with reference number 130 of FIG. 1B. As an example, the message may indicate that the second version of the code package is valid based on the second test results. The message may include an email message or a push notification, among other examples.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1E. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using a machine learning model on code packages, the system comprising:
one or more memories; and
one or more processors, communicatively coupled to the one or more memories, configured to:
receive a first version of a first code package;
compile, and perform a first set of tests on, the first version of the first code package;
provide a first set of results from the first set of tests to the machine learning model in order to generate a first score for the first version of the first code package;
receive a second version of the first code package;
compile, and perform the first set of tests on, the second version of the first code package;
provide a second set of results from the first set of tests to the machine learning model in order to generate a second score for the second version of the first code package, wherein the second score is worse than the first score;
receive, from a first user device, a request for the first code package;
transmit, to the first user device and in response to the request for the first code package, an indication to use the first version of the first code package based on the second score being worse than the first score;
receive a first version of a second code package;
compile, and perform a second set of tests on, the first version of the second code package in order to determine that the first version of the second code package is defective; and
transmit, to a second user device, a message indicating that the first version of the second code package is defective.

2. The system of claim 1, wherein the one or more processors are configured to:
receive a second version of the second code package;
compile, and perform the second set of tests on, the second version of the second code package in order to determine that the second version of the second code package is valid; and
transmit, to the second user device, a message indicating that the second version of the second code package is accepted.

3. The system of claim 1, wherein the one or more processors, to receive the first version of the first code package, are configured to:
receive a set of files including computer code for the first version of the first code package.

4. The system of claim 1, wherein the first set of tests includes at least one debugging test or at least one security test.

5. The system of claim 1, wherein the one or more processors, to provide the first set of results to the machine learning model in order to generate the first score, are configured to:
transmit, to a machine learning host associated with the machine learning model, a request including the first set of results; and
receive, from the machine learning host and in response to the request, an indication of the first score.

6. The system of claim 1, wherein the one or more processors are configured to:
refrain from storing the first version of the second code package based on the first version the second code package being defective.

7. A method of selecting versions from a package repository, comprising:
transmitting, to the package repository and from a user device, a request for a code package;
receiving, from the package repository and at the user device, an indication of a plurality of versions of the code package;
receiving, from the package repository and at the user device, an indication of a suggested version from the plurality of versions, wherein the suggested version is based on automatic testing of the code package by the package repository;
transmitting, to the package repository and from the user device, a request for the suggested version; and
receiving, from the package repository and at the user device, at least one file included in the suggested version.

8. The method of claim 7, wherein the request for the code package includes an identifier associated with the code package.

9. The method of claim 7, wherein the code package comprises a set of files including software code.

10. The method of claim 7, wherein the code package comprises bytecode.

11. The method of claim 7, wherein the code package comprises at least one library including executable functions.

12. The method of claim 7, wherein the plurality of versions are associated with a respective plurality of scores, and the indication of the suggested version comprises an indication that the suggested version is associated with a highest score in the respective plurality of scores.

13. The method of claim 7, wherein the indication of the plurality of versions is represented in a user interface (UI), and the indication of the suggested version comprises a visual indicator included in the UI.

14. A non-transitory computer-readable medium storing a set of instructions for submitting to a package repository, the set of instructions comprising:
one or more instructions that, when executed by one or more processors of a device, cause the device to:
transmit, to the package repository, a request to store a first version of a code package;
receive, from the package repository, a message indicating that the first version of the code package is defective based on first test results at the package repository;
transmit, to the package repository, a request to re-assess a second version of the code package; and
receive, from the package repository, a message indicating that the second version of the code package is accepted based on second test results at the package repository.

15. The non-transitory computer-readable medium of claim 14, wherein the one or more instructions, when executed by the one or more processors, cause the device to:
transmit, to the package repository, a set of credentials,
wherein the request to store the first version of the code package is accepted based on the set of credentials being validated.

16. The non-transitory computer-readable medium of claim 14, wherein the request to store the first version of the code package comprises an application programming interface call.

17. The non-transitory computer-readable medium of claim 14, wherein the one or more instructions, when executed by the one or more processors, cause the device to:
transmit a request for a webpage associated with the package repository; and
receive the webpage in response to the request for the webpage,
wherein the request to store the first version of the code package is transmitted in response to interaction with the webpage.

18. The non-transitory computer-readable medium of claim 14, wherein the request to re-assess the second version of the code package comprises an application programming interface call.

19. The non-transitory computer-readable medium of claim 14, wherein the message indicating that the first version of the code package is defective comprises an email message or a push notification.

20. The non-transitory computer-readable medium of claim 14, wherein the message indicating that the second version of the code package is accepted comprises an email message or a push notification.
